(19) United States
(12) Patent Application Publication
(10) Pub. No.: US 2008/0225736 A1
(43) Pub. Date: Sep. 18, 2008

(54) TRANSMISSION OF SEGMENTS OF DATA PACKAGES IN ACCORDANCE WITH TRANSMISSION SPEED AND PACKAGE SIZE

(76) Inventors: MATTHEW CHARLES COMPTON, Tucson, AZ (US); Louis Daniel Echevarria, Tucson, AZ (US); Andrew Gary Hourselt, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/686,811

(22) Filed: Mar. 15, 2007

(51) Int. Cl. H04J 1/16

(52) U.S. Cl. 370/252; 370/474

(57) ABSTRACT

Adaptive data transmission is accomplished by allotting transmission to data of a data package via a communications connection. In one embodiment, the steps comprise determining the transmission speed available using an open connection; estimating time of transmission of the data package in accordance with the determined transmission speed and size of the data package; comparing the time of transmission to a predetermined maximum time limit, and if the time of transmission is within the predetermined maximum time limit, allotting transmission via the open connection to the data package; else, if the time of transmission exceeds the predetermined maximum time limit, breaking the data package into segments, each of which fits within the predetermined maximum time limit, assigning priorities to each the segment in accordance with information within each the segment, and allotting transmission via the open connection to the one of the segments having the highest priority.

### FIELD OF THE INVENTION

This invention relates to the field of data transmission, and, more particularly, to transmission of data packages over connections potentially having different transmission speeds.

### BACKGROUND OF THE INVENTION

The amount of data that is transmitted between and within data handling systems continues to grow. The same is true of service information, where the size of required service information needed for monitoring system health, diagnosing problems, as well as resolving those problems also continues to grow. For example, in a network where there is a limited amount of bandwidth available, the transmittance of service information to the appropriate party may take a very long time, leading to limited remote access to the sending device, increased amount of time for vital problem information to be made available, and possibly data send failure. Further, different networks, in addition to having different speeds, may have different quality of service levels, such as noise levels, packet loss and transmission timeout values. For example, a large transmission may have failed on a slow connection because it took longer than the maximum transmission time.

### SUMMARY OF THE INVENTION

Adaptive data transmission systems, computer program products and methods are provided for allotting transmission via a communications connection to data of a data package.

In one embodiment, the steps comprise:

determining the transmission speed available using an open connection;

estimating time of transmission of the data package in accordance with the determined transmission speed and size of the data package;

comparing the time of transmission to a predetermined maximum time limit; and

if the time of transmission is within the predetermined maximum time limit, allotting transmission via the open connection to the data package;

else, if the time of transmission exceeds the predetermined maximum time limit, breaking the data package into segments, each of which fits within the predetermined maximum time limit, assigning priorities to each segment in accordance with information within each the segment, and allotting transmission via the open connection to the one of the segments having the highest priority.

Another embodiment additionally comprises the steps of initially opening the connection, and closing the connection subsequent to transmission of one of the data package and the highest priority segment.

A further embodiment additionally comprises the step of queuing the remaining segments.

A still further embodiment additionally comprises the steps of, if the data package is encoded files, unencoding the data package, splitting the data package into files, sorting the files by priority, and re-encoding and accumulating files by priority into a segment which fits within the predetermined maximum time limit.

For a fuller understanding of the present invention, reference should be made to the following detailed description taken in conjunction with the accompanying drawings.

### BRIEF DESCRIPTION OF THE DRAWINGS

FIG. 1 is a block diagram illustrating a communication system which implements embodiments of the present invention;

FIG. 2 is a schematic representation of a data package, a predetermined time limit and segments of the data package; and

FIG. 3 is a flow chart depicting the processing to allot transmission via a communications connection to data of a data package.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

Referring to FIG. 1, a communication system 10 comprises a device or system 20 having a data package 30 for transmission to a receiver 40. In one embodiment, the device or system 20 comprises a data handling device or system that communicates over a network or communications link 50 with respect to many devices and/or systems, one of which is receiver 40. Examples of data handling devices or systems comprise the IBM® 3584 tape library subsystem, the IBM® 3494 virtual tape storage system, the IBM® Blade Center, the IBM® 3090 Enterprise Storage Server, etc. In addition, an application protocol 55, such as HTTP, etc., may be used to transfer the data packages. The present invention allows the application protocol to work without taking into account the quality of service of the network or the data package size.

In one embodiment, the data package 30 comprises service information about the device or system 20, and the potential receiver 40 for that service information may comprise an administration station of an administrator for the device or system 20 that is located remotely from the device or system 20.

In one embodiment, the service information of data package 30 may comprise information monitoring system health, information indicating the presence of a problem or problems, and/or information useful for diagnosing problems.

The present invention may allot transmission of the data package 30 so as to both prevent disruption to other data communication with respect to the device or system 20 and to allow at least the highest priority data of the data package to be transmitted to the receiver 40.

The invention can take the form of an entirely hardware embodiment, an entirely software embodiment or an embodiment containing both hardware and software elements. In a preferred embodiment, the invention is implemented in software, which includes but is not limited to resident software, microcode, firmware, etc.

Furthermore, the invention can take the form of a computer program product accessible from a computer usable or computer readable medium providing program code for use by or in connection with a computer or any instruction execution system. For the purposes of this description, a computer usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer readable medium include a semiconductor or solid state memory, magnetic tape, a removable computer diskette, and random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Connections 50 to the receiver 40 may encompass connection links including intervening private or public networks. The communication links may comprise serial interconnections, such as RS-232 or RS-422, Ethernet connections, SCSI interconnections, ESCON interconnections, FICON interconnections, a Local Area Network (LAN), a private Wide Area Network (WAN), a public wide area network, Storage Area Network (SAN), Transmission Control Protocol/Internet Protocol (TCP/IP), the Internet, and combinations thereof.

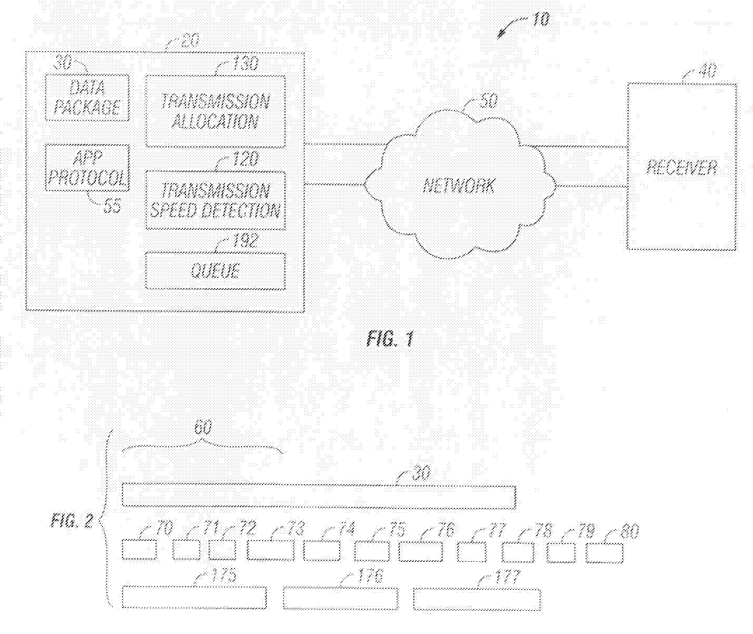

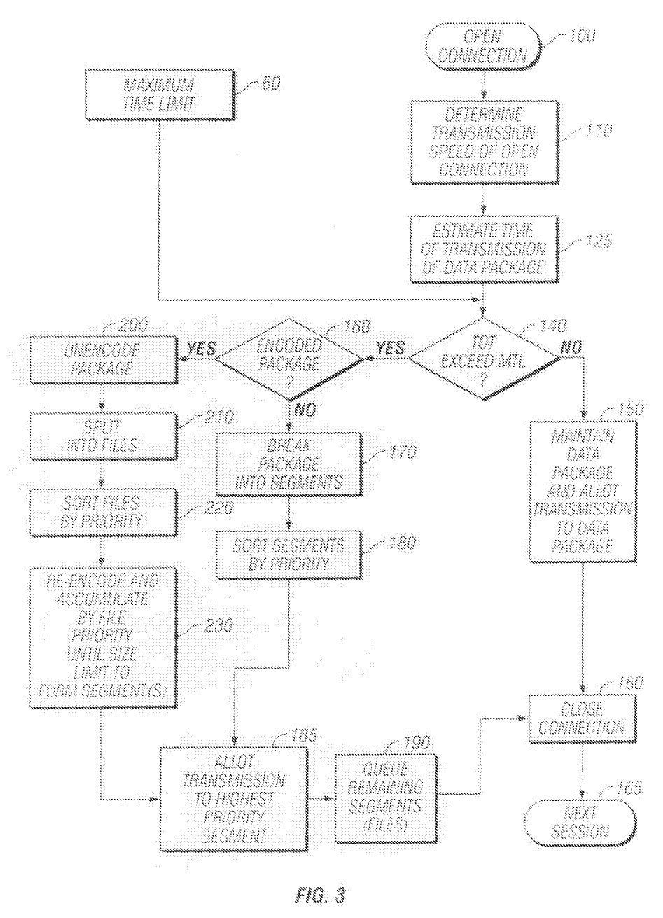

Referring to FIGS. 1, 2 and 3, a maximum time limit setting or threshold 60 is made by a system administrator, a service administrator, or by the customer or user of the system 10 or of the device or system 20. The maximum time limit may be fixed, or may vary on circumstances, such as time of day. Herein, the maximum time limit is termed “predetermined” in the sense that it is established on or before a connection is opened. The data package 30 may constitute a package of data that has accumulated, or is developed in response to an inquiry, or is a posting by the device or system 20 requesting an attention by the administrator or other person or system at the receiver 40, or a combination.

In step 100, a connection is opened over the network 50 to the receiver 40. The connection may be opened by a command or sequencing between or by adapters at the device or system 20 or as the result of a command received on the network.

In step 110, the transmission speed of the specific connection is determined by a transmission speed detection module 120. The speed detection module may comprise hardware or software or a combination as discussed above, and may measure the speed that the transmission precursors are transmitted and responses are received, may measure the speed that a sample message is transmitted, or may read the interaction between transmitting and receiving adapters to determine the elements of the device or system 20, network 50 and receiver 40 and calculate a transmission speed based on those elements. In one example, the transmission speed is measured in bits per second.

In step 125, a transmission allocation module 130 estimates the time of transmission of the data package 30. The transmission allocation module may comprise hardware or software or a combination as discussed above. The transmission allocation module, for example, may estimate the time of transmission of the data package 30 by dividing the size or length of the data package by the transmission speed provided by the transmission speed detection module 120. In one example, the size or length of the data package is measured in bits. The computation of the time of transmission, in one example, comprises TIME=(SIZE/Speed)/(60 seconds/minute).

In step 140, the transmission allocation module 130 compares the time of transmission to the predetermined maximum time limit 60.

If, the time of transmission is within the predetermined maximum time limit, the transmission allocation module 130 allots transmission via the open connection to the data package 30 in step 150, and the device or system 20 will transmit the data package via network 50 to receiver 40 as per the appropriate protocols. After the data package has been sent, the connection is closed in step 160, and the device or system waits in step 165 for the next session. Closing the connection will allow the same, similar or different connections to be established to conduct the more operational communications of the device or system 20. If another package is or becomes ready to send, the next session will begin at step 100 when the same or another connection is opened.

However, if step 140 indicates that the estimated time of transmission for the entire data package 30 exceeds the predetermined maximum time limit 60, the entire package will not be transmitted. Rather, step 168 determines whether the data package is one computer file that contains multiple file records that are compressed or encoded in some way. If now, in step 170, the transmission allocation module 130 breaks the data package 30 into segments 175, 176, 177, each of which fits within the predetermined maximum time limit 60. The number of segments will depend on the size of the data package and the method of arranging the segments. In step 180, the transmission allocation module 130 ascertains the information in the segments or repackages the segments, and determines given priorities or assigns priorities to each of the segments in accordance with information within that segment, and sorts the segments by priority. For example, information indicating the presence of a problem or problems may have the highest priority, and information useful for diagnosing problems may have the next highest priority. Information monitoring system health may have the lowest priority.

In step 185, the transmission allocation module 130 allots transmission via the open connection to the one of the segments 175, 176, 177, having the highest priority, and the device or system 20 will transmit the segment of the data package via network 50 to receiver 40 as per the appropriate protocols. In step 190, the transmission allocation module 130 queues the remaining segments, for example, in queue 192. After the data package has been sent, the connection is closed in step 160. Closing the connection will allow similar or different connections to be established to conduct the more operational communications of the device or system 20.

Data packages 30 may comprise archive files or groupings of data that contain multiple files internally which are compressed or encoded in some way. Herein, such packages are said to comprise “encoded files”. If step 168 indicates that the data package 30 is such a package, the archive file or grouping is unencoded in step 200. In step 210, the data of the package is split into its list of files, and, in step 220, the files are sorted by priority. For example, the sorted files may comprise file 70 through file 80.

In step 230, the files are re-encoded and the highest priority files accumulated or added together until the size limit of the predetermined maximum time limit is approached or reached, to form a highest priority segment 175. The remaining files may also be re-encoded and accumulated by priority to form additional segments 176, 177. Alternatively, the remaining files may be queued in step 190.

The priorities of the files may be previously given or the transmission allocation module 130 may assign priorities in accordance with information within the file, or some other basis.

In step 185, the transmission allocation module 130 allots transmission via the open connection to the segment having the highest priority, and the device or system 20 will transmit the segment of the data package via network 50 to receiver 40, as per the appropriate protocols. The remaining segments or files are queued in step 190, for example, in queue 192, and, after the segment has been sent, the connection is closed in step 160.

Step 165 comprises waiting for the next session for an available open connection in which the data package segments may be transmitted. For example, if a new data package is ready, the new package will be compared to the maximum time limit, etc. If not, a queued segment will be transmitted. If the time of transmission has been increased, the queued segment may be treated as a new data package, as above.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. An adaptive data transmission system, comprising:
a transmission speed detection module configured to determine the transmission speed available using an open connection; and
a transmission allocation module configured to:
estimate time of transmission of a given data package in accordance with said determined transmission speed and size of said data package;
compare said time of transmission to a predetermined maximum time limit; and
if said time of transmission is within said predetermined maximum time limit, allot transmission via said open connection to said data package;
else, if said time of transmission exceeds said predetermined maximum time limit, break said data package into segments, each of which fits within said predetermined maximum time limit, assign priorities to each said segment in accordance with information within each said segment, and allot transmission via said open connection to the one of said segments having the highest said priority.

2. The adaptive transmission system of claim 1, wherein said transmission allocation module is additionally configured to initially open said connection, and configured to close said connection subsequent to transmission of one of said data package and said highest priority segment.

3. The adaptive transmission system of claim 2, wherein said transmission allocation module is additionally configured to queue the remaining said segments.

4. The adaptive transmission system of claim 1, wherein said transmission allocation module is additionally configured to, if said data package comprises encoded files, unencode said data package, split said data package into files, sort said files by priority, and re-encode and accumulate at least one of said files by priority into a segment which fits within said predetermined maximum time limit.

5. A method for allotting transmission via a communications connection to data of a data package, comprising the steps of:
determining the transmission speed available using an open connection;
estimating time of transmission of said data package in accordance with said determined transmission speed and size of said data package:
comparing said time of transmission to a predetermined maximum time limit; and
if said time of transmission is within said predetermined maximum time limit, allotting transmission via said open connection to said data package;
else, if said time of transmission exceeds said predetermined maximum time limit, breaking said data package into segments, each of which fits within said predetermined maximum time limit, assigning priorities to each said segment in accordance with information within each said segment, and allotting transmission via said open connection to the one of said segments having the highest said priority.

6. The method of claim 5, comprising the steps of initially opening said connection, and closing said connection subsequent to transmission of one of said data package and said highest priority segment.

7. The method of claim 6, comprising the step of queuing the remaining said segments.

8. The method of claim 5, comprising the steps of, if said data package comprises encoded files, unencoding said data packages, splitting said data packages into files, sorting said files by priority, and re-encoding and accumulating at least one of said files by priority into a segment which fits within said predetermined maximum time limit.

9. A computer program product comprising a computer useable medium having a computer readable program, wherein the computer readable program, when executed on a computer, causes the computer to:
determine the transmission speed available using an open communication connection;
estimate time of transmission of a given data package in accordance with said determined transmission speed and size of said data package:
compare said time of transmission to a predetermined maximum time limit; and
if said time of transmission is within said predetermined maximum time limit, allot transmission via said open communication connection to said data package;
else, if said time of transmission exceeds said predetermined maximum time limit, break said data package into segments, each of which fits within said predetermined maximum time limit, assign priorities to each said segment in accordance with information within each said segment, and allot transmission via said open communication connection to the one of said segments having the highest said priority.

10. The computer program product of claim 9, wherein said computer readable program, when executed on a computer, causes the computer to initially open said communication connection, and to close said communication connection subsequent to transmission of one of said data package and said highest priority segment.

11. The computer program product of claim 10, wherein said computer readable program, when executed on a computer, causes the computer to queue the remaining said segments.

12. The computer program product of claim 9, wherein said computer readable program, when executed on a computer, causes the computer to, if said data package comprises encoded files, unencode said data package, split said data package into files, sort said files by priority, and re-encode and accumulate at least one of said files by priority into a segment which fits within said predetermined maximum time limit.
